(19) United States
(12) Patent Application Publication
(10) Pub. No.: US 2008/0226818 A1
(43) Pub. Date: Sep. 18, 2008

(54) Method for Through Repair of a Composite Structure Comprising Three Skins and Two Core Layers

(75) Inventors: Christophe Bernus, Toulouse (FR); Jean-Claude Marty, Grepiac (FR); Jacques Fournie, Grenade (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Airbus France, Toulouse (FR)

(21) Appl. No.: 12/066,668

(22) PCT Filed: Sep. 27, 2006
(86) PCT No.: PCT/EP06/66811

§ 371 Date: Mar. 13, 2008

(30) Foreign Application Priority Data
Sep. 29, 2005 (FR) 05/52952

(51) Int. Cl. B32B 43/00

(52) U.S. Cl. 427/140

(57) ABSTRACT

A method for through-repair of a composite material structure. Repair portions, established through two core layers, for example as a honeycomb and three polymer skins, including two external skins and a middle skin inserted between the core layers to obtain a composite structure, are set up and the polymer is hardened in vacuum. A counter-form is pressed onto one of the skins to guarantee a good aspect and surface quality. Vents are provided through the middle skin and possibly through the skin receiving the counter-form for proper degassing of the underlying cellular core.

The invention relates to a method for through-repair of a so-called double sandwich composite structure comprising two layers of a cellular internal core between a pair of external skins, and a middle skin located between both core layers.

Composite structures are encountered in a lot of apparatus, notably transportation, railway, seagoing, or aeronautical machines; for example on ship hulls, or on external streamline shapes, leading edges of wings, aircraft ailerons and radomes. The use of the middle skin provides certain advantages of radio-electric transparency.

The structure is often damaged to a degree which imposes that it be replaced locally. New portions of the skins and of the core layers are set up at the location of the repair by extending the intact portions and the new portions of the skins are left to harden. In order to guarantee a nicely smooth repaired surface on the outside of the structure, and without any difference in level between the original skin and the edge of the new portion of this skin, a counter-form is laid and pressed on the new portions before hardening, in order to bring the repair portion to level with the original structure.

There is a risk of a bonding failure between the new portions of the skins and of the core layers in spite of the pressure of the counter-form. The object of the invention is to eliminate this risk and to provide quality of the bond between the new portions.

The bonding failure may arise from the lack of setting up pressure of the core on the skins during baking, when accomplishing hardening, itself caused by the pressure of the air which is entrapped in the cells of the core layers and which the pressure of the counter-form prevents from emerging from underneath the edges of the new skin portion. In the usual methods, the portion to be repaired of the structure is wrapped up in a vacuum bag forming a chamber in which a vacuum is applied in order to pump the excesses of resin and drain this air in order to facilitate removal from the mold, but draining is not always achieved in a satisfactory way.

In the case of a through-repair applied to a sandwich or double sandwich composite structure where stacked portions of all the skins and layers of the core are replaced, air can escape from the structure through the side which is not compressed by the counter-form, but draining is in reality only accomplished for the closest core layer to this side, since the other layer of the core, which is adjacent to the skin compressed by the counter-form, is also limited by the middle skin, which forms another barrier to draining air. Precautions should therefore be taken in order to provide complete draining of such composite structures comprising two layers of an internal core separated by a middle skin. In the known methods, this is accomplished by proceeding with the hardening of skin layers in several steps in the way which will be indicated further on, which is long and not very economical. A method is proposed here, the essential benefit of which is to shorten the time required for the repair, without however challenging the quality. In its general embodiment, it consists, in such a structure and for replacing portions of all the layers with new portions, of laying a rigid counter-form on the new portion of the first external skin and around it, pressing the counter-form on the composite material structure and hardening the new portions of the external skins and of the middle skin, characterized in that it comprises, before hardening, a step for piercing the new portion of the middle skin and draining the air contained in the first layer and the second layer of the internal core.

In a particular embodiment before the hardening and draining, the method comprises a step for piercing the new portion of the first external skin.

Hardening may be accomplished in two steps, or even in a single one in the particular embodiment above, instead of three steps according to the prior method.

These aspects of the invention, as well as other aspects, will now be described in connection with the following figures:

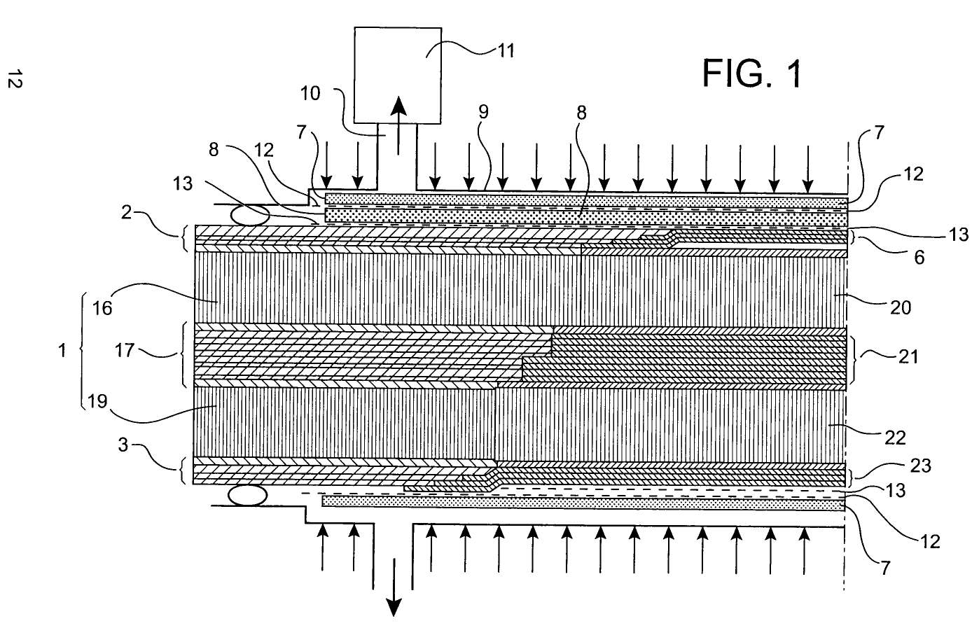

FIG. 1 is a general view of a standard repair method,

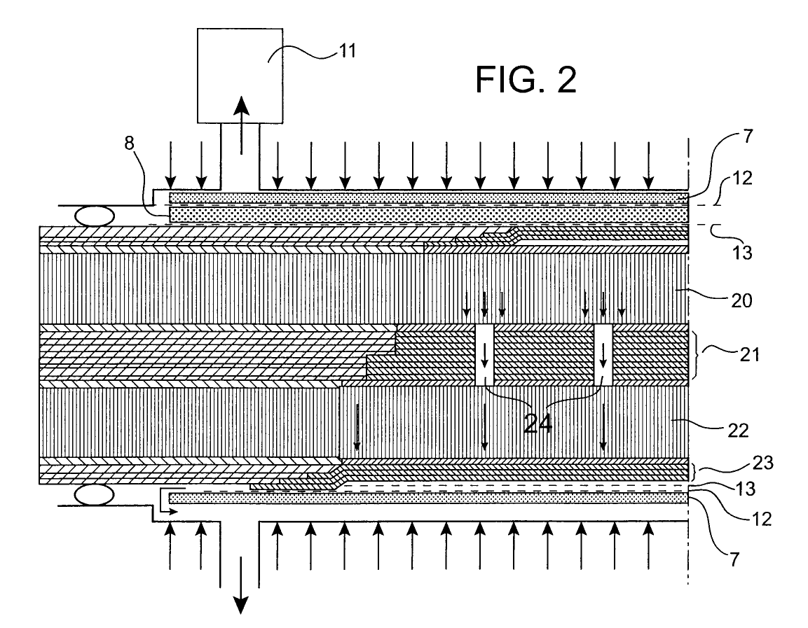

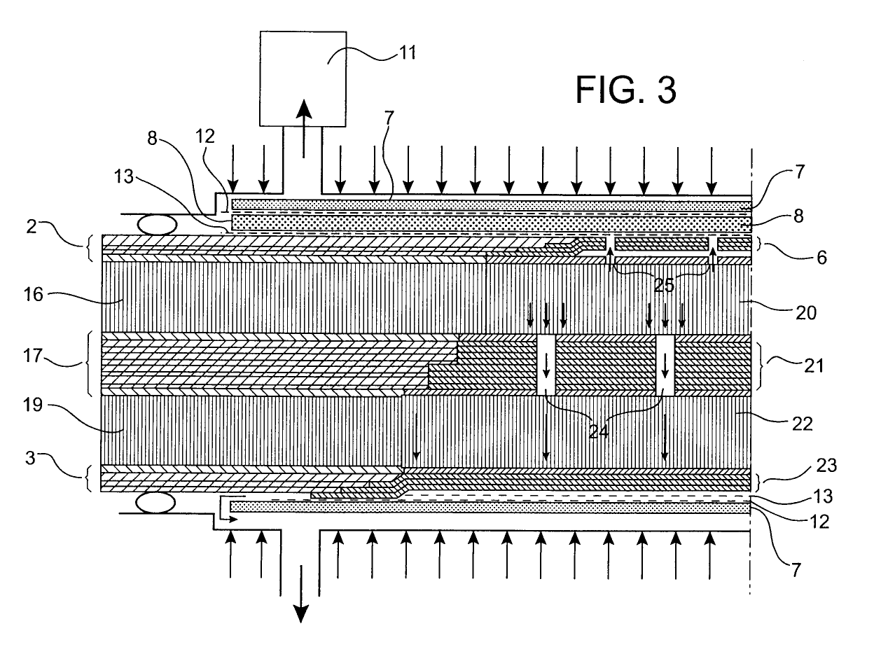

and FIGS. 2 and 3 illustrate two main alternative embodiments of the invention.

The structure of FIG. 1 comprises an internal structure 1 and two opposite outer skins 2 and 3, between which the internal structure 1 is inserted with adhesive bonding. The outer skins 2 and 3 generally consist of folded polymer layers which are successively draped and then hardened. The internal structure 1 consists of two cellular core layers 16 and 19 often consisting of a honeycomb structure, the cells of which extend from one of the external skins 2 to the other one 3. Both of these core layers are separated by a third skin which is a middle skin 17 of the same nature as the external skins 2 and 3. Repair consists of replacing a portion of the structure with a new portion consisting of a new skin portion 6 extending the external skin 2 on the outer side of the structure, of a new first core layer portion 20 extending the first core layer 16, of a new middle skin portion 21 extending the middle skin 17, of a new second core layer portion 22 extending the second core layer 19 and of a new skin portion 23 extending the external skin 3 on the inner side of the structure; the new portions 6, 20, 21, 22 and 23 are stacked on each other in this order.

Traditional tooling comprises a counter-form 8, usually in the shape of a plate which is laid on the new skin portion 6. The lower face of the counter-form 8 pressing on the new skin portion 6 and around it, on a border of the original external skin 2, has a shape and surface quality corresponding to those which are intended to be obtained for the external skin 2 after the repair. The counter-form 8 is pressed onto the external skin 2 and compresses the new skin portion 6. This is achieved by confining the portion to be repaired of the structure in a vacuum bag 9, the vents 10 of which are connected on each face of the structure to a vacuum pump 11 or a similar apparatus. Heating carpets 12 are slipped into the vacuum bag 9 in order to bake the polymer layers of the new skin portions 6 impregnated with resin. Heating may also be achieved by other means such as infrared heating. The lower face of the counter-form 8 is often coated with polytetrafluoroethylene (PTFE) in order to provide easy removal of the mold after hardening; a pealable sheet 13 may also be slipped under it, in contact with the new skin portion 6. Finally, environment fabrics 7 are placed between the internal faces of the vacuum bag 9 and the heating carpet 12. Draining is carried out through them.

The vacuum pump 11 sucks the air included in the vacuum bag 9, but it is incapable of suitably doing this for the air included in the cells of the internal cores 16 and 19 under the new skin portion 6, since the pressure of the counter-form 8 prevents it from flowing through under the edge of the new skin portion 6 while producing sufficient adherence for the seal with the original portion of the external skin 2. Bonding defects between the new skin and core portions may appear after hardening.

In known embodiments of the repair method, the new skin portion 6 is first draped and then the new portion of the first core layer 20 is set up on it and hardening is accomplished; and then the new middle skin portion 21 is draped, the new portion of the second core layer 22 is set up, and hardening of the new portion of middle skin 21 is accomplished; and finally the new external skin portion 23 opposite to the preceding one (6) is draped and then hardened. This method in three distinct hardening steps may take several days, whereas the inventive method is much shorter. It consists before achieving the first hardening, of also setting up the new middle skin portion 21 and the second core layer 22 and of piercing vent holes 24 therein. Applying a vacuum then produces evacuation of the air present in the new portion of the first core layer 20 through the vent holes 24 illustrated in FIG. 2. The joint and simultaneous hardening of the middle skin new external skin portions 6 and 21 may then be accomplished. The new portion of the opposite external skin 23 is then set up and the latter is left to harden in a second and last step. The resin impregnating the folds of the new middle skin portion 21 having flowed into the vents 24 and having blocked them by hardening (except if they are excessively wide); proper anchoring between the honeycomb of the first core layer 16 and the middle skin 17 is achieved.

An alternative of the invention consists of accomplishing the hardening of all the new portions 6, 21 and 23 and the draining of all the new portions of the core layers 20 and 22 in a single step, which is possible if the vents 24 are sufficiently numerous, and notably in the case of FIG. 3. Pierced vents 25 through the new external skin portion 6 located on the side of the counter-form 8 are added to the already encountered vents 24, allowing air present in the new portion of the first core layer 20 to be degassed on both sides sufficiently easily so that the hardening of all the new portions of the skins 6, 21 and 23 is accomplished at the same time. The vents 25 are also blocked at the same time by the resin impregnating the new portion 6 and flowing during heating. The surface quality of the external skin 2 is not jeopardized if the vents 25 occupy a small surface area. In practice, they will be made by means of a punch or a spike. Their calibre will therefore be finer than that of the vents 24.

The number, the size and the arrangement of the vents will be selected from the width of the portion to be repaired and from the other dimensional parameters. Current arrangements for the vents 24 may therefore comprise a single vent 24 at the centre of the repaired portion, or a circle of a few vents, which will then be narrower, at a same distance from the centre of this repaired portion.

1-4. (canceled)

5. A method for through-repair of a composite material structure successively including: a first external skin, a first cellular core layer, a middle skin, a second cellular core layer, and a second external skin, the method comprising:
replacing portions of the external skins of the middle skin and of the core layers with new portions;
laying a rigid counter-form on the new portion of the first external skin and around the new portion;
pressing the counter-form onto the composite material structure and hardening the new portions of the external skins and the middle skin; and
before the hardening, piercing the new portion of the middle skin and draining the air contained in the first layer and the second layer of the internal core.

6. The method for through-repair of a composite material structure according to claim 5, further comprising, before the hardening and draining, piercing the new portion of the first external skin.

7. The method for through-repair of a composite material structure according to claim 5, wherein the hardening is performed in only first and second operations, the first operation relating to the new portions of the first external skin and of the middle skin, the second operation relating to the new portion of the second external skin, the new portions of the second core layer and of second external skin being set up between the first and second operations.

8. The method for through-repair of a composite material structure according to claim 6, wherein the hardening is accomplished in a single operation.
